(19) United States
(12) Patent Application Publication
(10) Pub. No.: US 2007/0187366 A1
(43) Pub. Date: Aug. 16, 2007

(54) Heater chip for thermocompression bonding

(76) Inventor: Tatsuya Ishii, Aichi (JP)

Correspondence Address: CLARK & BRODY, 1090 VERMONT AVENUE, NW, SUITE 250, WASHINGTON, DC, 20005, US

(21) Appl. No.: 10/568,591

(22) PCT Filed: Mar. 24, 2004
(86) PCT No.: PCT/JP04/04008

§ 371 Date: Nov. 3, 2006

(30) Foreign Application Priority Data
Aug. 22, 2003 (JP) 2003-299002

(51) Int. Cl. B23K 11/30

(52) U.S. Cl. 219/56.21

(57) ABSTRACT

A heater chip for thermocompression bonding, where the degree of heating at the thermocompression bonding part does not vary among individual heater chips and durability is enhanced. On the heater chip for thermocompression bonding, a small projection-like thermocompression bonding portion (2) heated up by conduction resistance is provided on a small plate-like body (1), at the front of the plate of reduced width. A cut (3) is provided at the end of the body, toward the vicinity of the thermocompression bonding portion. Both sides of the cut serve as conduction terminals (1a, 1b). A thermocouple (5) for temperature detection is installed in the vicinity of the thermocompression bonding portion (2). A projection portion (7) for thermo-welding the temperature detection portion of the thermocouple is provided on the inner side surface of the cut or on the outer peripheral side surface of the body.

### FIELD OF THE INVENTION

This invention relates to a heater chip for thermocompression bonding to be used with a resistance welding machine for connecting a conducting wire to an electrode of an electric component or the like.

### BACKGROUND ART

The prior invention entitled “A Heater Chip for Thermocompression Bonding” (JP2002-139566) was filed by the same applicant to this present invention. FIGS. 10 to 12 of this invention are the same drawings reprinted from the above prior invention.

As shown in FIG. 10, the heater chip B for thermocompression bonding of the prior invention is a small metal plate body 51 of over a ten-millimeter length of a longitudinal shape.

The tip of the narrowed end of the body 51 comprises a small projection-like thermocompression bonding portion 52 heated up by conduction resistance.

A cut 53 is provided in the body, from the center of the base end toward to the vicinity of the thermocompression bonding portion 52. Both sides of the cut serve as a conducting terminal portion 51a, 51b and as the mounting portion of the heater chip B. A cut 54 is a through-hole provided to fix the body 51.

The body 51 is made of a wrought tungsten alloy comprising an internal structure of many thin layers.

A cut 55 is provided in the vicinity of the thermocompression bonding portion 52 at the head of the body 51 so that a thermocouple 60 for detecting the temperature of the thermocompression bonding portion 52 can be installed therein.

The thermocouple 60 incorporates the structure of the temperature-detecting portion 63 wherein two materially different conducting wires such as a chromel wire 61 and an alumel wire 62 are bound up together in parallel, and both ends of the conducting wires are thermally fused.

The temperature-detecting portion 63 is of a structure therein the two conducting wires are positioned through the cut 55 and thermally fused, and at the same time, as shown in FIG. 11, the two parallel wires across the cut 55 are thermo-welded on the inner side of the body 51. Also, as shown in FIG. 12 which is a cross-sectional view along the line Y-Y in FIG. 11, the temperature-detecting portion 63 is thermally fused and a wet spreading portion flows and then covers up the top to bottom section of the temperature-detecting portion 63.

As described above, the body 51 has an internal structure of multiple thin layers. Therefore, the marginal part of the cut 55 is negatively affected by the repeated heating and cooling and may be delaminated with time. And then the temperature-detecting portion 63 will easily fall apart from of the cut 55, and eventually the durability performance of the heater chip will deteriorate.

However, even in such a circumstance, the delamination can be prevented if the peripheral area near the cut 55 is covered up with the peripheral area of the temperature-detecting portion 63 as shown in FIG. 12, since the peripheral area of the cut 55 can be vertically clamped by the temperature-detecting portion 63. Thus, durability of the heater chip can be greatly improved. However, the aforementioned prior invention can be further improved.

In fact, even if the condition of electric conduction in the body 51 is unchangeable, the degree of heating the thermocompression bonding portion 52 varies among the conventional heater chips.

The above unfavorable heat variation has been examined from various angles, and the following causes were found.

Referring to an example of the conventional invention as shown in FIG. 11, the temperature-detecting portion 63 extending across the cut 55 is thermo-welded. And a meltage on the left side of the temperature-detecting portion 63 is obviously larger than that on the right side of the temperature-detecting portion 63.

When forming the temperature-detecting portion 63 by using the thermo-welding method, melting heat is transferred to the conduction terminals 51a and 51b relatively in the cut 55. However, as shown in FIG. 10, since the heat capacity varies depending on each shape of the cut 55, in other words, more melting heat is transferred to the right portion of the cut 55 which has more heat capacity. Therefore, it is understood that the temperature of the right portion is reduced more than that of the left portion.

And it is also understood that the meltage of the temperature-detecting portion 63 between the right and left portions of the cut 55 varies among individual heater chips. This is caused by a difference in conditions to provide the temperature-detecting portion 63 on the cut 55 by using the thermal fusion or thermo-welding method.

In this regard, the schematic equivalent circuits concerning the electrical resistance value of each portion of the body 51 are shown in FIG. 13.

In FIG. 13, the letter ‘n’ indicates the resistance of the heating point of the thermocompression bonding portion 52, and the letter ‘m’ indicates the resistance of the thermo-welding point of the temperature-detecting portion 63.

Each value of the resistance ‘m’ slightly varies among heater chips since the condition for thermo-welding the temperature-detecting portion 63 in the cut 55 slightly varies among the heater chips as described above.

Furthermore, if the condition for thermo-welding the temperature-detecting portion 63 in the cut 55 varies among individual heater chips, the heat transfer from the thermocompression bonding portion 52 to the temperature-detecting portion 63 will also vary. Thus, the electromotive force value of the temperature-detecting portion 63 which also controls the temperature of the thermocompression bonding portion 52 varies among individual heater chips.

Therefore, even if the condition of the electrical conduction is unchangeable, the temperature of the thermocompression bonding portion 52 will vary among individual heater chips.

Also, it is naturally considered that the above unfavorable heat variation of the thermocompression bonding portion 52 among individual heater chips is caused by the difference in thickness, size, or planar shape of the body 51.

However, such an unfavorable variation, caused by an inaccuracy occurring in the manufacturing process, can be easily overcome if the manufacturing is appropriately controlled.

The present invention is designed such that the aforementioned problems of heater chips in the prior invention can be resolved. This invention provides a heater chip for thermocompression bonding, where the degree of heating at the thermocompression bonding portion does not vary among individual heater chips and durability is enhanced.

### SUMMARY OF THE INVENTION

In order to achieve the aforementioned objectives, the present invention was designed such that the heater chip is characterized by comprising a structure wherein a small projection-like thermocompression bonding portion heated up by conduction resistance is provided on a small plate-like body, on the head end of reduced width, with a cut provided in the body, from the base end toward the vicinity of the thermocompression bonding portion, with both sides of the cut serving as a conduction terminal portion. A thermocouple for temperature-detecting portion is installed in the vicinity of the thermocompression bonding portion, therein a projection portion for thermo-welding the temperature-detecting portion of the thermocouple is provided on the inner side surface of the cut or on the outer peripheral side surface of the body.

The projection portion for thermo-welding is preferably provided in a protruding condition deep inside the cut and opposite to the thermocompression bonding portion.

Also, the protruding length of the projection portion for thermo-welding, from the base end side toward the apical surface where the temperature-detecting portion of the thermocouple is to be welded is preferably 0.4 millimeter or more.

Furthermore, this invention is characterized in that both joint ends of a pair of conducting wires are thermally fused so that the temperature-detecting portion is formed and also welded on the aforementioned projection portion for thermo-welding, and that each ridge of the apical surface of the projection portion for welding is covered with the wet-spreading periphery of the temperature-detecting portion so that the delamination with the lapse of time will not occur even in the body with the internal structure of thin layers.

Or, a hole is preferably provided along the aforementioned cut so that a pair of conducting wires to make up the thermocouple can be run through and firmly supported.

### BRIEF DESCRIPTION OF THE DRAWINGS

FIG. 1 is an oblique perspective view of a heater chip as a first embodiment of the invention.

FIG. 2 is a partially-enlarged oblique perspective view showing the vicinity of the thermocompression bonding portion and projection portion for thermo-welding the above heater chip.

FIG. 3 is a partially-enlarged vertical sectional view along the line Y-Y as indicated in FIG. 1.

FIG. 4 is a partially-enlarged flat view showing the vicinity of the thermocompression bonding portion and projection portion for thermo-welding the above heater chip.

FIG. 5 is a graph indicating the time-course variations of the electrical current flowing to the heater chip and electromotive value of the thermocouple.

FIG. 6 indicates two other embodiments of the invention, both showing a partial flat view of the vicinity of the thermocompression bonding portion and projection portion for thermo-welding.

FIG. 7 is a partially-enlarged oblique perspective view, showing two different welding conditions to provide the temperature-detecting portion on the projection portion for thermo-welding.

FIG. 8 is a partially enlarged flat view of the vicinity of the thermocompression bonding portion and temperature-detecting portion of the body, showing two inappropriate examples where the temperature-detecting portion of the thermocouple is welded to the body.

FIG. 9 is an equivalent circuit schematic of an electric resistance in the body.

FIG. 10 is an oblique perspective view of the conventional heater chip.

FIG. 11 is a partially-enlarged oblique perspective view of the heater chip incorporating the thermocouple.

FIG. 12 is a vertical cross sectional view of the Y-Y line as indicated in FIG. 11.

FIG. 13 is an equivalent circuit schematic of the electric resistance in the body.

### DESCRIPTION OF THE PREFERRED EMBODIMENTS

Referring now to the drawings, the specific structure of this invention is described below.

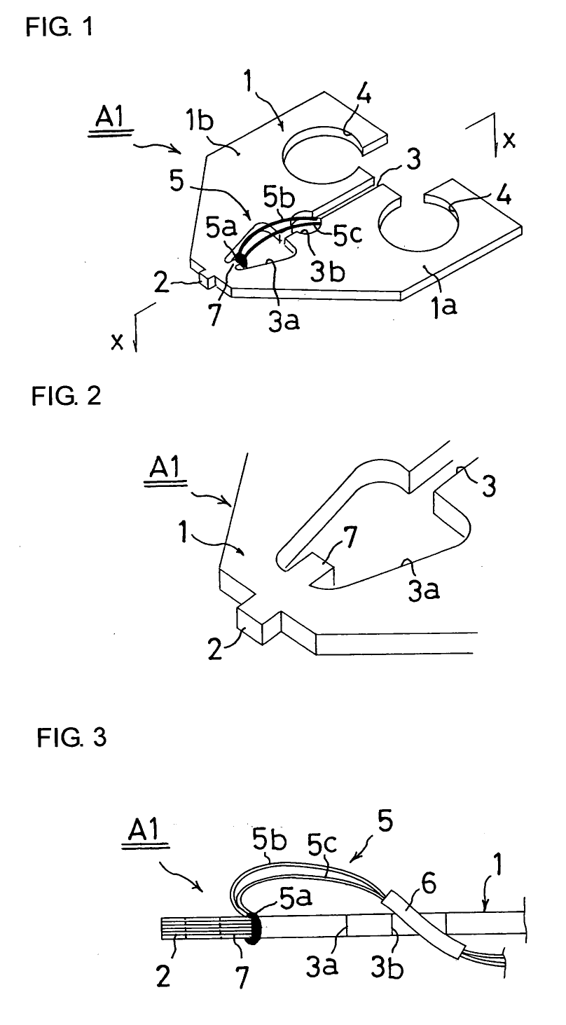

FIGS. 1 to 5 describe the first embodiment of this invention.

A heater chip A, as shown in the oblique perspective view of FIG. 1, is a body 1 made of a small and thin metal plate comprising a flat shape similar to a “Japanese chess piece”

The size of the body 1 of this embodiment is approximately 15×17 millimeters.

The body 51 is made of a wrought tungsten alloy comprising an internal structure of multiple thin layers.

A small projection-like thermocompression bonding portion 2 heated up by conduction resistance is provided in a protruding condition on the head end side having a reduced width.

A cut 3 is provided in the body 1, from the base end side toward the vicinity of the thermocompression bonding portion 2.

Both sides of the cuts serve as a conduction terminal portion, 1a and 1b and also function as an attaching portion of the heater chip A with a through-hole 4.

In FIG. 1 and FIG. 3 showing a partially enlarged vertical cross-sectional view along the X-X line of FIG. 1, a thermocouple 5 is provided to detect the heat of the thermocompression bonding portion 2, and as already described above, the thermocouple 5 is combined with two materially different conducting wires, such as a chromel wire 5b and an alumel wire 5c so that each end of the two different wires can be thermally welded and becomes the temperature-detecting portion.

The thermocouple 5 provides a feedback control function to obtain the heat of the thermocompression bonding portion 2 by the electrical conduction resistance into the body 1 and maintain the appropriate temperature for each work (not shown).

The width of the aforementioned cut 3 is not the same for all the plates. In other words, a dilated trapezoidal cut 3a is provided deep inside the cut 3.

Also, a small dilated cut 3b (for support) is provided nearly at the midpoint of the cut 3 in a longitudinal direction so that a pair of conducting wire 5b, 5c of the thermocouple 5 can be inserted and supported with a protection tube 6.

As shown in FIG. 2, a projection portion 7 for thermo-welding the temperature-detecting portion 5a is provided deep inside the small dilated cut 3a, opposite to the thermocompression bonding portion 2.

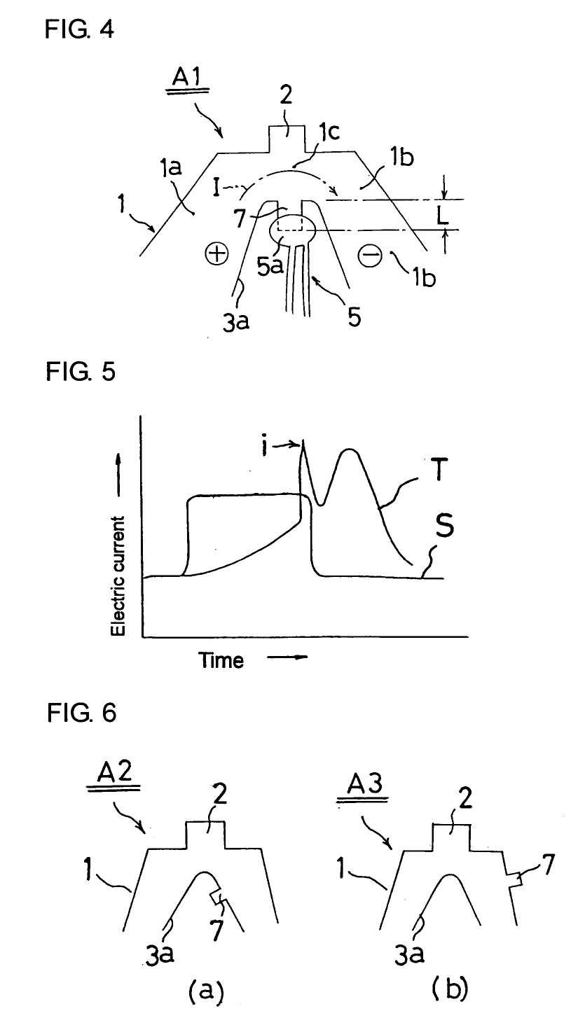

As shown in FIG. 4, the protruding length L of the projection portion 7 extending from the base end toward the apical surface where the temperature-detecting portion of the thermocouple is to be welded is preferably 0.4 millimeter or more.

A condition where the temperature-detecting portion 5a is thermo-welded into the projection portion 7 is simply described in FIG. 3 as a partially-enlarged vertical cross-sectional view of the X-X line in FIG. 1

The temperature-detecting portion 5a is formed by binding up the aforementioned two different conducting wires 5b, 5c in parallel and then thermally welding each end of the two conducting wires. At the same time, a melting portion is provided on the head area of the projection portion 7 for welding so that the wet melting portion spreads over the head area in a vertical direction and covers up the top and bottom ridges of the head area.

Function of the heater chip A is here described.

In the heater chip A, a pair of conduction terminals 1a, 1b of the body 1 are connected to a power section (not illustrated in the drawing) which produces a certain increase in temperature of the thermocompression bonding portion 2 by the conduction resistance.

The conduction heating at the thermocompression bonding portion 2 is detected as an electromotive force value of the temperature-detecting portion 5a in the thermocouple 5. According to the above detection signal, a conduction control circuit provided on the power section controls a feedback function to maintain a certain temperature of the thermocompression bonding portion 2.

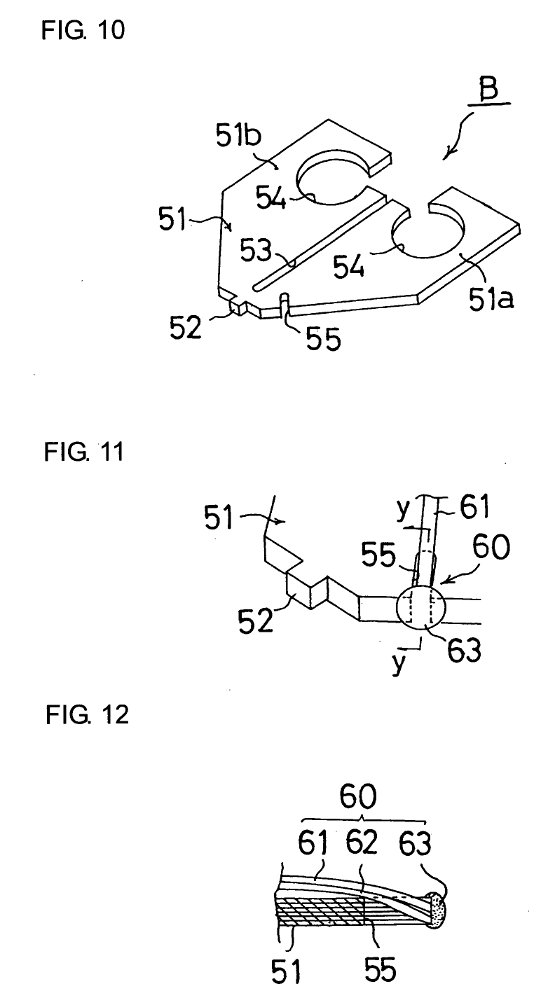

However, the conventional heater chip B as shown in FIGS. 10 and 11 is very difficult to replace since the degree of heating at the thermocompression bonding portion and electromotive force value vary among individual heater chips. And it is necessary to correct such unfavorable variations and to retain the correct feedback control when the heater chips become deteriorated with the lapse of time.

Meanwhile, there may be no such substantive variations among individual heater chips A1 in this invention.

Referring to FIG. 4, the reason why the inventive heater chips have no such unfavorable variations is described. When the heater chip A1 is electrically conducted, an electrical current I flows from the conduction terminal 1a of the positive electrode to the conduction terminal 1b of the negative electrode. An electric flow pathway 1c having a very narrow width is provided between the conduction terminals 1a and 1b.

The thermocompression bonding portion 2 connecting to the electric flow pathway 1c and the projection portion 7 welded with the temperature-detecting portion 5a heats up to the specific temperature by the conduction resistance in the electric flow pathway 1c.

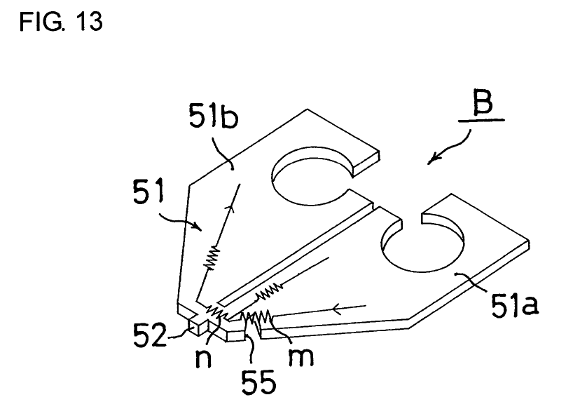

Now, a thermal welding position, i.e., a position of the cut 55 where the temperature-detecting portion 63 is thermally welded into the heater chip B of prior invention as shown in FIG. 13 is here compared with a thermal-welding position, i.e., a position of the projection portion 7 where the temperature-detecting portion 5a is thermally welded into the heater chip A1 as shown in FIG. 4.

The welding position of the temperature-detecting portion 63 in the former case is entirely included in the electric flow pathway of the body 51. Thus, the thermo-welding condition of the temperature-detecting portion 62 varies in some degree among individual heater chips. Therefore, the conduction resistance in the vicinity of the thermocompression bonding portion 52 and electromotive force value of the temperature-detecting portion 63 vary. As a result, the degree of heating at the thermocompression bonding portion 52 varies among individual heater chips.

On the other hand, the position of the projection portion 7 where the temperature-detecting portion 5a is thermally welded is outside of the area of the electrical current I flowing into the body 1 as shown in FIG. 4. Thus, in the present invention, even if the thermal welding condition of the temperature-detecting portion 5a varies among individual heater chips, the degree of heating at the thermocompression bonding portion 2 and electromotive force value of the temperature-detecting portion 5a will not vary.

Besides the above characteristic features, the heater chip A1 has other features as described below.

Referring now to FIG. 5, other features are here described. A graph S shown in FIG. 5 indicates the change over time in the electrical current which flows into the heater chip A1 or B, and the graph T indicates the change over time in the electromotive force value on the temperature-detecting portion 63 of the heater chip B.

When the electrical conduction into the body of the heater chip is turned off, the peak current flows immediately. However, in the case of heater chip B, the peak current i is unfavorably combined with the electric current of the temperature-detecting portion 63, which eventually provides wrong information on temperature detection. This is caused by the fact that the position for thermal welding the temperature-detecting portion 63 is provided inside the pathway of the electrical current flowing into the body 51.

On the other hand, the heater chip A1 has no such defect since the projection portion 7 for thermo-welding the temperature-detecting portion 5a is provided out of the pathway of the electrical current I flowing into the body 1.

The results of repeated experiments proved that the protruding length L (see FIG. 4) of the projection portion 7 extending from the base end toward the apical surface where the temperature-detecting portion 5a is to be welded should preferably be 0.4 millimeter or more. Then, such an abnormal peak current on the electromotive value of the temperature-detecting portion 5a can be avoided.

Meanwhile, in order to obtain the above excellent feature in this inventive heater chip, it is not always necessary to provide the projection portion 7 deep inside the cut 3, as shown in the heater chip A1

In other words as described above, in order to achieve the objective of this invention, the position for thermo-welding the temperature-detecting portion 5a, (or projection portion 7) can only be provided in a protruding condition on any appropriate side of the body 1 so that the position is placed outside of the area of the electrical current for heating the thermocompression bonding portion 52 in the body 1.

Then, as the heater chip A2 indicated in the drawing (a) of FIG. 6 or the heater chip A3 indicated in the drawing (b) of FIG. 6, the projection portion 7 can be provided on either inner side of the cut 3 in the body 1, or on either outer circumference of the body 1, but in either case, the projection portion 7 should be provided in the vicinity of the thermocompression bonding portion 2.

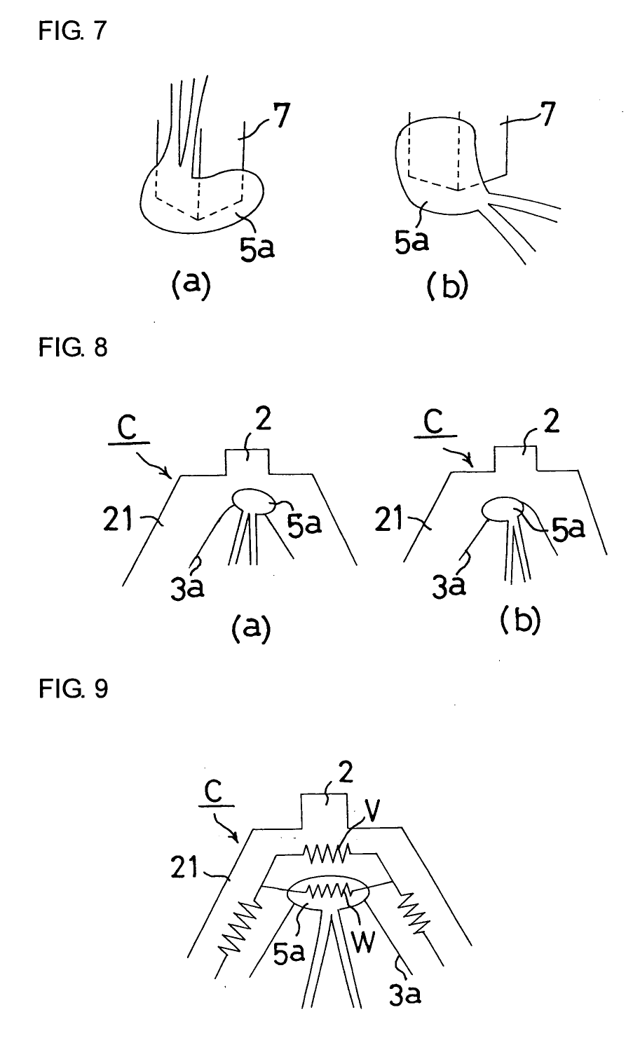

Now, another different feature of the inventive heater chip A will be here described referring to FIG. 3 and the drawing (a) of FIG. 7.

As shown in the drawings, when the temperature-detecting portion 5a of the thermocouple 5 is thermally welded into the head surface of the projection portion 7, the temperature-detecting portion 5a partially melts and the wet spreads toward the outer area of the head surface of the projection portion 7, and then covers up the ridges of the head surface.

The projection portion 7 of the body 1 comprises an inner structure of multiple thin layers. Such a structure is normally delaminated with time after repeated heating and cooling, and then the temperature-detecting portion 5a falls off. Therefore, the durability performance of the heater chip may deteriorate.

Also, such delamination reduces the electromotive force of the thermocouple 5 and makes it difficult to control the feedback of the heating temperature of the thermocompression bonding portion 2.

However, as described above, the ridges of the head surface of the projection portion 7 are covered with the peripheral area of the temperature-detecting portion 5a as if the head surface of the projection portion 7 were entirely covered and supported by a clamp so that the above delamination can be prevented. Thus, the durability performance of the heater chip A is greatly improved. Furthermore, the accurate feedback control of the heating temperature on the thermocompression bonding portion 2 can be regularly maintained without a decrease in the electromotive force value of the thermocouple 5 which is caused by delamination.

However, if the electromotive force of the thermocouple 5 decreases, the thermocompression bonding portion 2 will be excessively heated up due to erroneous feedback control. Then delamination will also be accelerated. Moreover, the thermo-welding position of the temperature-detecting portion 5a can also be provided on the bottom side (or top side) of the projection portion 7 as shown in the drawing (b) of FIG. 7, not on the head surface of the projection portion 7 as shown in the drawing (a) of FIG. 7. Although the above delamination cannot be prevented in this case, positioning the temperature-detecting portion 5a and the thermocompression bonding portion 2 can be done more easily. Therefore, if the projection portion 7 of the body 1 has no internal structure of layers or comprises some specific materials, the temperature-detecting portion 5a can be thermally welded into the projection portion 7 as shown in the drawing (b) of FIG. 7.

If the temperature-detecting portion 5a is directly thermal-welded into the deep area of the dilated cut 3a of the cut 3, not on the projection of the heater chip C, as shown in the drawings (a) and (b) of FIG. 8, the following defect will be considered.

In order to avoid the unfavorable variation in the heating temperature of the thermocompression bonding portion 2 among individual heater chips C, it is necessary to strictly maintain each position of the thermocompression bonding portion 2 and temperature-detecting portion 5a. However, it is very difficult to thermal-weld the temperature-detecting portion 5a while maintaining the same position among all the heater chips C. Also, the wet-spreading condition of the temperature-detecting portion 5 varies among the heater chips.

Differences in the above-mentioned positioning and wet-spreading among individual heater chips C is exaggeratingly indicated in the drawings (a) and (b) of FIG. 8.

Also, an equivalent circuit related to the internal electric resistance in the body 21 of the heater chip C is schematically illustrated in FIG. 9 in which a referential mark V indicates a resistance for heating up the thermocompression bonding portion 2, and W indicates a resistance of the temperature-detecting portion 5a. As shown in the drawing, the resistance W is connected in parallel to the resistance V and relates to the heat of the thermocompression bonding portion 2. And the value of the resistance W varies among individual heater chips C due to the differences in the aforementioned positioning and wet-spreading of the temperature-detecting portion 5a. Such an unfavorable variation results in another unfavorable variation in the degree of heating at the thermocompression bonding portion 2 among individual heater chips C.

### INDUSTRIAL APPLICABILITY

The heater chip for thermocompression bonding in this invention is mainly characterized in that a projection portion for thermo-welding the temperature-detecting portion of the thermocouple is provided on a specific side of the body, and that the aforementioned welding condition is specified.

Thus, compared to the conventional similar type of invention, this invention offers better functions as follows.
(a) Even if the condition for mounting the temperature-detecting portion of the thermocouple varies among individual heater chips, the degree of heating at the thermocompression bonding portion does not vary among the heater chips.
(b) Therefore, it is not necessary to correct such unfavorable variations and to retain the correct feedback control when the heater chips are deteriorated with time and replaced with new ones.
(c) A projection portion of the temperature-detecting portion is appropriately positioned away from the electrical current pathway into the thermocompression bonding portion so that the peak current, which is generated when the conduction to the heater chip is turned off, does not negatively affect the electromotive force value of the thermocouple.
(d) The temperature-detecting portion of the thermocompression bonding portion in the body comprising an internal structure of multiple thin layers is delaminated with time after repeated heating and cooling, and then the temperature-detecting portion 5a may fall off. However, in the present invention, specifying the thermo-welding condition of the temperature-detecting portion prevents such delamination, and then the durability performance of the heater chip is greatly improved.
(e) The accurate feedback control of the heating temperature on the thermocompression bonding portion can be regularly maintained without a decrease in the electromotive force value of the thermocouple which is caused by delamination.

What is claimed is:

1. A heater chip for thermocompression bonding characterized by comprising a structure wherein a small projection-like thermocompression bonding portion heated up by conduction resistance is provided on a small plate-like body, on the head end of a reduced width, a cut is provided in the body, from the base end side toward the vicinity of the thermocompression bonding portion, both sides of the cut serves as a conduction terminal portion, a thermocouple for the temperature-detecting portion is installed in the vicinity of the thermocompression bonding portion, therein a projection portion for thermo-welding a temperature-detecting portion of the thermocouple is provided on the inner side surface of the cut or on the outer peripheral side surface of the body.

2. A heater chip for the thermocompression bonding of claim 1 characterized in that the projection portion for thermo-welding is preferably provided deep inside the cut in a protruding condition and placed opposite to the thermocompression bonding portion.

3. A heater chip for thermocompression bonding of claim 2 characterized in that the protruding length of the projection portion for thermo-welding, from the base end toward the apical surface where the temperature-detecting portion of the thermocouple is to be welded, is preferably 0.4 millimeter or more.

4. A heater chip for thermocompression bonding of claim 1 characterized in that both joint ends of a pair of conducting wires are thermally fused so that the temperature-detecting portion is formed and also welded into the aforementioned projection portion for thermo-welding, and that each ridge of the apical surface of the projection portion for welding is covered with the wet-spreading periphery of the temperature-detecting portion so delamination with the lapse of time will not occur even in the body with an internal structure of multiple thin layers, and

5. A heater chip for thermocompression bonding of claim 1 characterized in that a cut is preferably provided along the aforementioned cut so that a pair of conducting wires to make up the thermocouple can be run through and supported.
